(19) United States
(12) Patent Application Publication
(10) Pub. No.: US 2019/0292285 A1
(43) Pub. Date: Sep. 26, 2019

(54) VINYL AROMATIC RESIN

(71) Applicants: DOW GLOBAL TECHNOLOGIES LLC, MIDLAND, MI (US); ROHN AND HAAS COMPANY, Philadelphia, PA (US); THE REGENTS OF THE UNIVERSITY OF CALIFORNIA, Oakland, CA (US)

(72) Inventors: G. Leslie Burnett, Santa Barbara, CA (US); Javier Read De Alaniz, Santa Barbara, CA (US); John C. Rohanna, Ambler, PA (US); Alfred K. Schultz, Maple Glen, PA (US); Steven Rosenberg, Shorewood, MN (US)

(21) Appl. No.: 16/302,337

(22) PCT Filed: Jun. 19, 2017
(86) PCT No.: PCT/US2017/038125

§ 371 Date: Nov. 16, 2018

Related U.S. Application Data
(60) Provisional application No. 62/353,079, filed on Jun. 22, 2016.

(51) Int. Cl. C08F 212/08; C08F 212/36; C08F 8/02; C08F 8/24

(52) U.S. Cl. CPC C08F 212/08; C08F 8/24; C08F 8/02; C08F 212/36

(57) ABSTRACT

Provided is vinyl aromatic resin comprising benzyl alcohol groups, benzyl ether groups, and methylene bridge groups,
wherein the mole ratio of the benzyl ether groups to the methylene bridge groups is from 0.002:1 to 0.1:1,
wherein the vinyl aromatic resin either has no amine groups or else has amine groups in a mole ratio of the sum of all amine groups to aromatic rings of 0.1:1 or lower.

It is desirable to provide adsorbent resins that remove impurities from water and that do not leach chloride ions into the water. It is often desirable that such adsorbent resins have a high degree of crosslinking. Some adsorbent resins with a high degree of crosslinking are vinyl aromatic resins, for example copolymers of styrene and divinyl benzene, in which some of the crosslinks are methylene bridges between aromatic rings. Typically, such methylene bridges have been introduced into resins using chemical reaction schemes that involve compounds containing chlorine atoms, and after the reaction schemes were complete, chlorine atoms were left in the resin, either covalently attached to the resin or as part of a molecule resident on the resin or in some other form. Whatever the form of the chlorine atom, the presence of chlorine atoms greatly increases the risk that chloride ions could leach from the resin, and such leaching is, in some situations, extremely undesirable. It is desired to provide a resin that has very low level of chlorine atoms.

It is also desired that the resin should perform well in the function of removing impurities from water. For example, it is often desired to remove colloidal cobalt from water. One form of colloidal cobalt the removal of which is often desired is cobalt that is present in the cooling water of a nuclear reactor. Such cobalt may be, for example, resident on or part of a colloidal particle formed from corrosion products. When exposed to neutrons, the cobalt may become radioactive, and the radioactivity makes the removal of the colloidal cobalt highly desirable.

East German Patent DD 249,274 discloses adsorber polymers useful for hemoperfusion that are produced by postreticulation of crosslinked polystyrenes. DD 249,274 describes a process involving producing a chloromethylated resin, then aminating the resin, followed by washing with methanol, then saponifying any residual chloromethyl groups on the resin in an alkaline manner or by etherifying with polyols or polyethylene glycols. It is desired to provide a non-aminated polymer that has a low level of chlorine and that is suitable for removing colloidal cobalt. It is also desired to provide a process of making such a resin that provides improved removal of cobalt. It is also desired to provide an improved method of removing colloidal cobalt from water.

The following is a statement of the invention.

A first aspect of the present invention is a method of treating a vinyl aromatic resin (I) comprising
(a) bringing the vinyl aromatic resin (I) into contact with an alcohol, and maintaining the contact between the vinyl aromatic resin (I) and the alcohol for 10 minutes or more, and
(b) bringing the vinyl aromatic resin into contact with a base.
   wherein the vinyl aromatic resin (I), prior to steps (a) and (b), has benzyl chloride groups, benzyl alcohol groups, and methylene bridge groups.

A second aspect of the present invention is a vinyl aromatic resin comprising benzyl alcohol groups, benzyl ether groups, and methylene bridge groups, wherein the mole ratio of the benzyl ether groups to the methylene bridge groups is from 0.002:1 to 0.1:1, wherein the vinyl aromatic resin either has no amine groups or else has amine groups in a mole ratio of the sum of all amine groups to aromatic rings of 0.1:1 or lower.

A third aspect of the present invention is method of removing colloidal cobalt from an aqueous composition comprising bringing the aqueous composition into contact with a vinyl aromatic resin, wherein the vinyl aromatic resin comprises benzyl alcohol groups, benzyl ether groups, and methylene bridge groups, wherein the vinyl aromatic resin has a chlorine content, by weight based on the weight of resin, of 10,000 ppm or less.

The following is a detailed description of the invention.

As used herein, the following terms have the designated definitions, unless the context clearly indicates otherwise.

“Resin” as used herein is a synonym for “polymer.” A “polymer,” as used herein is a relatively large molecule made up of the reaction products of smaller chemical repeat units. Polymers may have structures that are linear, branched, star shaped, looped, hyperbranched, crosslinked, or a combination thereof; polymers may have a single type of repeat unit (“homopolymers”) or they may have more than one type of repeat unit (“copolymers”). Copolymers may have the various types of repeat units arranged randomly, in sequence, in blocks, in other arrangements, or in any mixture or combination thereof. Polymers have weight-average molecular weight of 2,000 or more.

Molecules that can react with each other to form the repeat units of a polymer are known herein as “monomers.” The repeat units so formed are known herein as “polymerized units” of the monomer.

Vinyl monomers have the structure VM

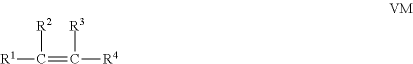

where each of R¹, R², R³, and R⁴ is, independently, a hydrogen, a halogen, an aliphatic group (such as, for example, an alkyl group), a substituted aliphatic group, an aryl group, a substituted aryl group, another substituted or unsubstituted organic group, or any combination thereof. Vinyl monomers have molecular weight of less than 2,000. Vinyl monomers include, for example, styrene, substituted styrenes, dienes, ethylene, ethylene derivatives, and mixtures thereof. Ethylene derivatives include, for example, unsubstituted and substituted versions of vinyl acetate and acrylic monomers.

“Substituted” means having at least one attached chemical group such as, for example, alkyl group, alkenyl group, vinyl group, hydroxyl group, alkoxy group, carboxylic acid group, other functional groups, halogen, and combinations thereof.

As used herein, an aromatic carbon atom is a member of an aromatic ring.

As used herein, vinyl aromatic monomers are vinyl monomers in which one or more of R¹, R², R³, and R⁴ contains one or more aromatic ring. A substituted vinyl aromatic monomer is a vinyl aromatic monomer in which one or more chemical group other than hydrogen is attached to one or more of the aromatic carbon atoms.

A monovinyl monomer is a vinyl monomer that has exactly one non-aromatic carbon-carbon double bond per molecule. A multivinyl monomer is a vinyl monomer that has two or more non-aromatic carbon-carbon double bonds per molecule.

A polymer in which 90 mole % or more of the polymerized units are polymerized units of one or more vinyl monomers is a vinyl polymer. A polymer in which 90 mole % or more of the polymerized units are polymerized units of one or more vinyl aromatic monomers is a vinyl aromatic polymer.

As used herein, a vinyl aromatic polymer is said to have a benzyl alcohol group if there is one or more group of structure —CH₂—OH, where the group is attached to an aromatic carbon atom. As used herein, a vinyl aromatic polymer is said to have a benzyl chloride group if there is one or more group of structure —CH₂—Cl, where the group is attached to an aromatic carbon atom. As used herein, a vinyl aromatic polymer is said to have a benzyl ether group if there is one or more group of structure —CH₂—O—R, where the group is attached to an aromatic carbon atom, where R is a substituted or unsubstituted alkyl group.

As used herein, a vinyl aromatic polymer is said to have a methylene bridge group if there is one or more group of structure —CH₂—, where the group is attached to two different aromatic carbon atoms that are members of two different aromatic rings.

An amine group is a chemical group selected from primary, secondary, tertiary, and quaternary amine groups. Primary, secondary, and tertiary amine groups may be in the neutral form or may be protonated to form a cationic group. A vinyl aromatic polymer is considered herein to be aminated when an amine group is attached to an aromatic carbon atom.

An alcohol is an organic compound containing an —OH group that is attached to a non-aromatic carbon atom. An alkyl alcohol is an alcohol having the structure R⁵—OH, where R⁵ is an unsubstituted alkyl group.

As used herein, a base is a compound that has a conjugate acid, and the pKa of the conjugate acid is 7.5 or higher.

A collection of particles is characterized by the diameters of the particles. If particle is not spherical, the diameter of the particle is considered to be the diameter of a particle having the same volume as the particle. A collection of particles is characterized herein by the volume-average diameter of the collection. A particle is considered solid herein if the particle is in the solid state over a temperature range that includes 0° C. to 80° C. The surface area of a collection of solid particles is determined by the Brunauer-Emmett-Teller (BET) method.

One way to characterize a resin is to measure the chlorine content, which is the total amount of chlorine atoms present, measured by neutron activation analysis, in parts per million (ppm) by weight based on the weight of the resin.

As used herein, a substance is water-insoluble if the maximum amount of that substance that can be dissolved in 100 grams of water at 23° C. is 0.1 gram or less.

As used herein, a colloidal suspension is a composition in which dispersed particles of a water-insoluble substance are distributed throughout a continuous liquid medium. The continuous liquid medium contains water in an amount of 50% or more by weight based on the weight of the continuous liquid medium. The volume-average diameter of the dispersed particles is 5 nm to 5 μm. The colloidal suspension is stable, which means that the dispersed particles remain dispersed without agglomerating at the top or the bottom of the container when stored for up to 24 hours at 23° C.

“Colloidal cobalt” refers to cobalt that is present in dispersed particles of a colloidal suspension.

A compound is said herein to be soluble in a solvent if the amount of the compound that dissolves in 100 grams of solvent at 23° C. is 2 grams or more.

A compound is said to be a non-swelling compound for a polymer if, when equal amounts by weight of the compound and the polymer are brought into contact and allowed to stand in contact at 23° C. for 1 minute, the amount of compound that is imbibed into the polymer by swelling is 2 grams or less of imbibed compound per 100 grams of polymer.

A polymer is said to have a “corresponding monomer mixture,” which is a mixture of monomers of the types and proportions that are the same as the types and proportions of polymerized units that are present in the polymer. For example, if a polymer has 80% by weight polymerized units of styrene and 20% by weight polymerized units of divinylbenzene (DVB), then the corresponding monomer mixture has 80% styrene monomer by weight and 20% DVB by weight.

For a given polymer, a porogen is a compound that is soluble in the corresponding monomer mixture of the polymer and that is a non-swelling compound for the polymer.

When a ratio is said herein to be X:1 or greater, it is meant that the ratio is Y:1, where Y is greater than or equal to X. For example, if a ratio is said to be 3:1 or greater, that ratio may be 3:1 or 5:1 or 100:1 but may not be 2:1. Similarly, when a ratio is said herein to be W:1 or less, it is meant that the ratio is Z:1, where Z is less than or equal to W. For example, if a ratio is said to be 15:1 or less, that ratio may be 15:1 or 10:1 or 0.1:1 but may not be 20:1.

The present invention involves performing a treatment on a vinyl aromatic resin. The vinyl aromatic resin immediately prior to the treatment is known herein as vinyl aromatic resin (I). The vinyl aromatic resin (I) preferably has polymerized units of one or more monovinyl aromatic monomers and one or more multivinyl aromatic monomer. Among monovinyl aromatic monomers, preferred are styrene, alpha-methyl styrene, vinyl toluene, vinyl naphthalene, vinyl benzyl chloride, vinyl benzyl alcohol, and mixtures thereof; more preferred is styrene. Among multivinyl aromatic monomers, preferred is divinyl benzene.

Vinyl aromatic resin (I) is considered herein to have polymerized units of a substituted monovinyl aromatic monomer based on the structure of the resin and not on the method of making the resin. The substituent group may have been present on the monomer prior to polymerization and still be present in the resin; or a preliminary resin may have been polymerized using, for example, styrene monomer, and then the substituent group may have been attached to the resin by a chemical reaction that was performed after the polymerization. For example, if a resin were made by polymerizing styrene to produce a polystyrene resin, and then chloromethyl groups (—CH₂C1) were attached by a chemical reaction to the polystyrene resin, then the resulting resin would be said herein to contain polymerized units of vinyl benzyl chloride. Alternatively, if a resin were made by polymerizing vinyl benzyl chloride, possibly along with one or more additional monomers, the resulting resin would also be said herein to contain polymerized units of vinyl benzyl chloride.

Preferably, the vinyl aromatic resin (I) contains polymerized units of monovinyl aromatic monomer in the amount of, by weight based on the weight of the vinyl aromatic resin (I), 55% or more; more preferably 65% or more; more preferably 75% or more; more preferably 85% or more; more preferably 90% or more. Preferably, the vinyl aromatic resin (I) contains polymerized units of monovinyl aromatic monomer in the amount of, by weight based on the weight of the vinyl aromatic resin (I), 99% or less; more preferably 98% or less; more preferably 97% or less.

Preferably, the vinyl aromatic resin (I) contains polymerized units of multivinyl aromatic monomer in the amount of, by weight based on the weight of the vinyl aromatic resin (I), 1% or more; more preferably 2% or more; more preferably 3% or more; more preferably 4% or more. Preferably, the vinyl aromatic resin (I) contains polymerized units of multivinyl aromatic monomer in the amount of, by weight based on the weight of the vinyl aromatic resin (I), 45% or less; more preferably 30% or less; more preferably 15% or less; more preferably 10% or less.

Preferably, the vinyl aromatic resin (I) contains methylene bridge groups. The amount of methylene bridge groups is usefully characterized by the mole ratio (RBR) of methylene bridge groups to polymerized units of monovinyl aromatic monomer. Preferably, in vinyl aromatic resin (I), RBR is 0.3:1 or higher; more preferably 0.4:1 or higher; more preferably 0.45:1 or higher. Preferably, RBR is 0.8:1 or lower; more preferably 0.6:1 or lower.

It is also useful to characterize the amount of polymerized units of unsubstituted monovinyl aromatic monomer in vinyl aromatic resin (I). A polymerized unit of an unsubstituted monovinyl aromatic monomer has an aromatic ring in which exactly one carbon atom in the aromatic ring is attached to the resin via a covalent bond and in which every other carbon atom in the aromatic ring is bonded only to atoms that are either hydrogen or that are other carbon atoms in the same aromatic ring. Preferably, in vinyl aromatic monomer (I), the mole % of polymerized units of unsubstituted monovinyl aromatic monomer, as a percentage of all the polymerized units of all the monomers, is 10% or less; more preferably 5% or less; more preferably 2% or less; more preferably 1% or less.

The vinyl aromatic resin (I) may or may not have any benzyl ether groups. The vinyl aromatic resin (I) may be usefully characterized by the mole ratio (REB) of benzyl ether groups to methylene bridge groups. Preferably REB is 0:1 to 0.0001:1, more preferably 0:1 to 0.00003:1; more preferably 0:1 to 0.00001:1; more preferably 0:1. Preferably the benzyl ether group, if present, has the structure —CH₂—O—R, where R is an unsubstituted alkyl group; more preferably an unsubstituted alkyl group having 1 to 4 carbon atoms; more preferably methyl.

The vinyl aromatic resin (I) may also be characterized by the mole ratio (RAB) of benzyl alcohol groups to methylene bridge groups. Preferably, RAB is 0.002:1 or higher; more preferably 0.005:1 or higher; more preferably 0.01:1 or higher. Preferably, RAB is 0.2:1 or lower; more preferably 0.1:1 or lower; more preferably 0.05:1 or lower.

Preferably, vinyl aromatic resin (I) has surface area of 500 m²/g or more; more preferably 750 m²/g or more; more preferably 900 m²/g or more.

The vinyl aromatic resin (I) may be made by any method. Preferably, a precursor vinyl aromatic resin (P1) is prepared in which 0 to 0.1 mole percent of the polymerized units contain any atom other than carbon and hydrogen. Preferably, no polymerized units of vinyl aromatic resin (P1) have any atom other than carbon and hydrogen. Preferably, vinyl aromatic resin (P1) is made by a process of aqueous suspension polymerization; more preferably aqueous suspension polymerization in the presence of a porogen. A porogen is a compound that is insoluble in water (i.e., solubility in 100 g of water at 25° C. of 1 gram or less) and has a boiling point of 150° C. or lower. As the polymerization proceeds, vinyl aromatic resin separates from the porogen, forming spatial regions of porogen that become pores when the porogen later evaporates.

Preferably, aromatic resin (P1) has surface area of 10 to 100 m²/g.

Preferably a process of chloromethylation is then performed on vinyl aromatic resin (P1) that results in a vinyl aromatic resin (P2) that has benzyl chloride groups. Alternatively, a vinyl aromatic resin (P2) is made by polymerizing vinyl benzyl chloride, one or more multivinyl aromatic monomer, and optionally one or more other monovinyl aromatic monomer.

Preferably, the vinyl aromatic resin (P2) is then subjected to a Friedel-Crafts chemical reaction to produce vinyl aromatic resin (I). The Friedel-Crafts reaction involves reacting the resin in the presence of a solvent, such as, for example, ethylene dichloride, in the presence of a Friedel-Crafts catalyst such as, for example, FeCl₃. It is contemplated that the Friedel-Crafts reaction causes the carbon atom in the —CH₂C1 group of a benzyl chloride group to become un-bonded from the chlorine atom and to become bonded to an aromatic carbon atom located on a new aromatic ring, thus forming a methylene bridge. It is also contemplated that the Friedel-Crafts reaction leaves some benzyl chloride groups unaffected and also that the Friedel-Crafts reaction converts some benzyl chloride groups to benzyl alcohol groups.

It is contemplated that vinyl aromatic resin (I) has chlorine content of higher than 10,000 ppm.

Preferably, vinyl aromatic resin (I) either contains no carboxyl groups or carboxylate groups or else, if carboxyl groups or carboxylate groups are present, the amount of polymerized units of monomers in vinyl aromatic resin (I) that contain a carboxyl group or a carboxylate group is, in mole percent based on vinyl aromatic resin (I), 1% or less; more preferably 0.3% or less; more preferably 0.1% or less. More preferably, vinyl aromatic resin (I) contains no carboxyl groups or carboxylate groups.

One aspect of the present invention involves treatment of vinyl aromatic resin (I). The treatment process involves bringing vinyl aromatic resin (I) into contact with one or more alcohol. Preferably vinyl aromatic resin (I) is in a wet state when it is brought into contact with alcohol. Being in a wet state means that the resin is present as part of a mixture (M1) that contains 20% to 60% resin by weight and 40% to 80% water by weight, and the sum the weights of resin and water is 90% or more by weight based on the weight of the mixture (M1).

Preferred alcohols are alkyl alcohols, more preferably alkyl alcohols with 1 to 3 carbon atoms, more preferably methanol. Alcohol and resin are brought into contact to form mixture (M2). Preferably, the weight ratio of alcohol to resin by weight in mixture (M2) is 0.5:1 or higher; more preferably 1:1 or higher; more preferably 1.5:1 or higher. Preferably, the weight ratio of alcohol to resin by weight in mixture (M2) is 3.5:1 or lower; more preferably 3:1 or lower; more preferably 2.5:1 or lower.

Preferably, mixture (M2) is stirred for 0.5 hour or more; more preferably stirred for 1 hour or more. Preferably, mixture (M2) is stirred for 8 hours or less. Preferably, the temperature at which mixture (M2) is maintained during stirring is 10° C. or higher; more preferably 15° C. or higher; more preferably 20° C. or higher. Preferably, the temperature at which mixture (M2) is maintained during stirring is 60° C. or lower; more preferably 40° C. or lower; more preferably 30° C. or lower.

The treatment process also involves bringing vinyl aromatic resin (I) into contact with one or more base. Base may be brought into contact with vinyl aromatic resin (I) simultaneously with bringing vinyl aromatic resin (I) into contact with alcohol. Preferably, vinyl aromatic resin (I) is brought into contact with one or more base after some of the alcohol has been removed from mixture (M2). A preferred method of removing some of the alcohol from mixture (M2) is decanting. Preferably, after some of the alcohol has been removed from mixture (M2), if the resulting mixture is stored without agitation for 1 hour or more, the resin particles will settle to the bottom of the container, and if sufficient liquid is present, some liquid will float to the top of the container. Preferably, after such a settling process, the amount of liquid floating at the top of the container is, by volume based on the total volume of (M2) after removing some of the alcohol, 20% or less; more preferably 10% or less; more preferably 5% or less; more preferably 2% or less.

When vinyl aromatic resin (I) is brought into contact with base after removing alcohol from mixture (M2), the result is mixture (M3). Preferred bases are alkali metal hydroxides, alkaline earth hydroxides, alkoxides, ammonia, organic amines, and mixtures thereof; more preferred are alkali metal hydroxides and mixtures thereof; more preferred is sodium hydroxide.

Base is preferably used in the form of a solution of the base dissolved in water. Preferably the concentration of the base in the solution is, by weight based on the weight of the solution, 1% or more; more preferably 2% or more; more preferably 5% or more. Preferably the concentration of the base in the solution is, by weight based on the weight of the solution, 25% or less; more preferably 20% or less; more preferably 15% or less.

Preferably, mixture (M3) is maintained for 1 hour or more; more preferably 2 hours or more; more preferably 3 hours or more. Preferably, mixture (M3) is maintained for 12 hours or less; more preferably 10 hours or less. Preferably, while mixture (M3) is maintained, it is held at a temperature of 50° C. or higher; more preferably 60° C. or higher; more preferably 70° C. or higher. Preferably, while mixture (M3) is maintained, it is held at a temperature of 99° C. or lower; more preferably 95° C. or lower. Preferably, while mixture (M3) is maintained, it is maintained under reflux conditions.

After mixture (M3) has been maintained, preferably mixture (M3) is brought to approximately 23° C. The vinyl aromatic resin is preferably then separated from mixture (M3); at this point the vinyl aromatic resin is herein called vinyl aromatic resin (II). Separation from mixture (M3) may be accomplished by decanting the base solution, bringing the vinyl aromatic resin (II) into contact with water, and decanting the water to produce wet resin (wet vinyl aromatic resin (II) is present as part of a mixture (M4) that contains 20% to 60% resin by weight and 40% to 80% water by weight, and the sum the weights of resin and water is 90% or more by weight based on the weight of the mixture (M5)). Optionally the water may be removed from the wet resin to produce a dry resin having 10% or less water by weight based on the weight of the resin.

Vinyl aromatic resin (II) may be characterized by the mole ratio (RAB) of benzyl alcohol groups to methylene bridge groups. Preferably, RAB of vinyl aromatic resin (II) is 0.0002:1 or higher; more preferably 0.0004:1 or higher; more preferably 0.0006:1 or more; more preferably 0.0008:1 or more. Preferably, RAB of vinyl aromatic resin (II) is 0.5:1 or less; more preferably 0.2:1 or less; more preferably 0.1:1 or less.

Vinyl aromatic resin (II) may be characterized by the mole ratio (REB) of benzyl ether groups to methylene bridge groups. Preferably, REB of vinyl aromatic resin (II) is 0.002:1 or higher; more preferably 0.005:1 or higher; more preferably 0.008:1 or higher; more preferably 0.01:1 or higher. Preferably, REB of vinyl aromatic resin (II) is 0.05:1 or lower; more preferably 0.025:1 or lower.

Preferably, vinyl aromatic resin (II) has chlorine content, measured by neutron activation analysis, by weight based on the weight of resin, of 10,000 ppm or less; more preferably 9,500 ppm or less.

Preferably, vinyl aromatic resin (II) either has no carboxyl groups or else has carboxyl groups in a mole ratio of carboxyl groups to aromatic rings of 0.03:1 or lower; more preferably 0.01:1 or lower; more preferably 0.003:1 or lower; more preferably 0.001:1 or lower. A carboxyl group is considered to be present if the carboxyl group is either in the neutral protonated form or in anionic form.

Preferably, vinyl aromatic resin (II) either has no amine groups or else has amine groups in a mole ratio of the sum of all amine groups to aromatic rings of 0.1:1 or lower; 0.03:1 or lower; more preferably 0.01:1 or lower; more preferably 0.003:1 or lower; more preferably 0.001:1 or lower. A primary, secondary, or tertiary amine group is considered to be present if the amine group is either in the neutral form or in the cationic protonated form.

Vinyl aromatic resin (II) may usefully be characterized by the absence of or the amount of “additional” functional groups. An additional functional group is a chemical group that contains one or more atoms other than hydrogen and carbon and that is not a benzyl alcohol group and is not a benzyl ether group and is not a group that contains a chlorine atom. Preferably, vinyl aromatic resin (II) either has no additional functional groups or has additional functional groups in a mole ratio (MADD) of additional functional groups to aromatic rings of 0.03:1 or lower. That is, preferably MADD is 0:1 to 0.03:1. More preferably MADD is 0:1 to 0.01:1; more preferably 0:1 to 0.003:1; more preferably 0:1 to 0.001:1.

Preferably, vinyl aromatic resin (II) is in the form of solid particles. Preferably, the volume-average particle size is 50 μm or larger; more preferably 100 μm or larger. Preferably, the volume-average particle size is 750 μm or smaller; more preferably 500 μm or smaller.

A preferred use of vinyl aromatic resin (II) is removal of colloidal cobalt from an aqueous composition. Preferably the aqueous composition is a colloidal suspension in which the dispersed particles contain cobalt. The cobalt may be in the form of elemental cobalt or in the form of one or more oxide of cobalt, such as, for example, Co₃O₄ (also known as Co(II,III) oxide). In some embodiments, the dispersed particles contain one or more oxide of iron, and the amount of oxides of iron in the dispersed particles may be, for example, by weight based on the weight of the dispersed particles, 50% or more; more preferably 75% or more. In some embodiments, the dispersed particles contain one or more oxide of cobalt.

Preferably, the amount of cobalt in the aqueous composition, by weight of all colloid particles that contain cobalt, based on the weight of the aqueous composition, is 100 ppm or less; more preferably 50 ppm or less. Preferably, the amount of cobalt in the aqueous composition, by weight of all colloid particles that contain cobalt, based on the weight of the aqueous composition, is 1 ppm or more; more preferably 2 ppm or more; more preferably 5 ppm or more; more preferably 10 ppm or more.

A preferred method of bringing the aqueous composition into contact with vinyl aromatic resin (II) is to provide vinyl aromatic resin in the form of particles as described above. The particles are preferably placed in a vessel that allows aqueous solution to flow into the vessel through an entrance, to make intimate contact with the particles as it passes through the vessel, and then to flow out of the vessel through an exit, while keeping the particles trapped in the vessel. The aqueous composition is then forced, by gravity or by mechanical-applied pressure, into the vessel, into intimate contact with the particles, and then out of the vessel.

The following are examples of the present invention.

Resin-I used as vinyl aromatic resin (I). In Resin-I was a styrene/divinyl benzene copolymer that was subjected to chemical reactions so that Resin-I contained benzyl chloride groups, benzyl alcohol groups, and methylene bridge groups; and the mole ratio of benzyl ether groups to methylene bridge groups was in the range of 0:1 to 0.001:1. The mole % of aromatic rings in Resin-I that are connected to one end of one or more methylene bridges is over 50%.

### EXAMPLE 1: TREATED RESIN-I

The procedure for treating Resin-I was as follows. 300 mL of wet Resin-I was added to a round bottom flask equipped with a temperature probe, reflux condenser, and overhead stirrer. 300 mL of methanol was added and stirred for a Methanol Soak Time of 1-8 hours at room temperature (approximately 23° C.) open to the atmosphere. The methanol was decanted and 300 mL of 10% aq. NaOH was added and heated to 90 to 95° C. over 1 hours and held at reflux for a Caustic Reflux Time of 4-8 hours. The reaction was cooled to room temperature (approximately 23° C.) and the resin was isolated.

The chlorine content of resins was measured by neutron activation analysis (NAA) before and after the treatment process. The NAA method used was as follows.

Before treatment, Samples were prepared by transferring approximately 4 grams of the resin into pre-cleaned 2-dram polyethylene vials. Standard aliquots of Cl were prepared by transferring appropriate amounts of a NIST-traceable chlorine standard solution into similar vials. The standards were diluted to the same volume as the samples using pure water. A blank sample, containing the pure water only, was also prepared. The vials were heat-sealed. The samples, standards and the blank were then analyzed for chlorine by neutron activation analysis (NAA), as follows. The samples were irradiated for 10 minutes at 3 kW of reactor power. After a waiting time of 10 minutes, the gamma spectroscopy was done for 400 seconds each. These spectra were used to analyze for chlorine. The elemental concentrations were calculated using these spectra, the Canberra™ software and the standard comparative technique.

After treatment, samples were prepared by transferring approximately 7 grams of the water sample into pre-cleaned 2-dram polyethylene vials. Standard aliquots of Cl were prepared by transferring appropriate amounts of a NIST-traceable chlorine standard solution into similar vials. The standards were diluted to the same volume as the samples using pure water. A blank sample, containing the pure water only, was also prepared. The vials were heat-sealed. The samples, standards and the blank were then analyzed for Cl by NAA as follows. The samples were irradiated for 40 minutes at 250 kW of reactor power. After a waiting time of 10 minutes, the samples were transferred into un-irradiated vials and the gamma spectroscopy was done for 400 seconds each. These spectra were used to analyze for chlorine. The elemental concentrations were calculated using Canberra™ software and standard comparative technique.

Eight different batches of Resin-I were treated as described above. Chlorine content was determined before and after treatment (“Tmt”). Results were as follows:

Chlorine Content (ppm by weight based on resin weight)

| | Chlorine | | | |
|---|---|---|---|---|
| Treated | Before | Methanol Soak | Caustic Reflux | Chlorine After |
| Resin | Tmt (ppm). | Time (hr) | Time (hr) | Tmt (ppm) |
| Resin-e | 12550 | 8 | 4 | 1980 |
| Resin-f | 55550 | 1 | 7 | 2280 |
| Resin-g | 43000 | 1 | 7 | 2320 |
| Resin-h | 43000 | 8 | 4 | 2650 |
| Resin-a | 43000 | 8 | 7 | 3250 |
| Resin-b | 43000 | 0⁽¹⁾ | 7 | 5600 |
| Resin-i | 15250 | 1 | 7 | 8689 |
| Resin-d | 12550 | 1 | 4 | 9407 |

Note:
⁽¹⁾methanol was decanted immediately after resin and methanol were brought together and then stirred.

In each resin, the treatment significantly reduced the chlorine content. Also, all the untreated resins had chlorine content above 10,000 ppm, while after treatment all the resins had chlorine content of below 10,000 ppm.

Comparison of resins a, b, g, and h, which all had 43,000 ppm of chlorine at the outset, shows that methanol soak time of 0 had the least effectiveness at removing chlorine.

The amounts of various chemical groups were studied by nuclear magnetic resonance (NMR) spectroscopy. ¹³C NMR spectra were obtained at ambient temperature on a Bruker Avance III 400WB spectrometer operating at 100.6 MHz with a 4.0 mm MAS triple resonance broadband probe. The resins were spun at 14.0 kHz in a 4.0 mm zirconia rotor with a Kel-F cap. ¹³C chemical shifts were externally referenced to adamantane. Cross polarization magic angle spinning (CP-MAS) spectra were acquired with a ¹H 90° pulse length of 2.3 μs, 2 ms contact time, 3.0 s recycle delay, and approximately 1500-7500 transients. The acquisition time was 20.5 ms with a spectral width of 50 kHz. CP-MAS spectra were processed with 25 or 50 Hz exponential line broadening. The resins were placed under vacuum (approximately 10 Torr) for 24 hours prior to analysis. Resins are characterized as being tested either before or after treatment. Results were as follows:

TABLE 1
Functional Group Ratios

| Resin | Treatment | ratio REB⁽²⁾ | ratio RAB⁽³⁾ |
|---|---|---|---|
| Resin-a | after | 0.0165:1 | 0.0166:1 |
| Resin-b | after | 0.0125:1 | 0.0271:1 |
| Resin-c | after | 0.0124:1 | 0.0292:1 |
| Resin-d | after | 0.0094:1 | 0.0221:1 |
| Resin-I⁽⁴⁾ | before | 0:1 | 0.0666:1 |

Note:
⁽²⁾mole ratio of benzyl ether groups to methylene bridge groups
Note:
⁽³⁾mole ratio of benzyl alcohol groups to methylene bridge groups
Note:
⁽⁴⁾Reference Example

The treated resins all had significant amount of benzyl ether groups, while the untreated reference resin had no benzyl ether groups.

### EXAMPLE 2: PERFORMANCE OF RESINS

Cobalt oxide nanopowder was 1720HT from Nanostructured and Porous Materials, Co₃O₄ powder, 99% purity, particle size 50-80 nm.

For the mixed bed of ion exchange resins, the following were used:
AMBERLITE™ IRN78 resin=strong base gel type polystyrene anion exchange resin, supplied by Dow Chemical Company
AMBERLITE™ IRN99 resin=strong acid gel type polystyrene cation exchange resin, supplied by Dow Chemical Company
   The mixed bed was prepared by mixing 66% by weight AMBERLITE™ 78 with 34% by weight AMBERLITE™ 99. The mixed bed was placed in a glass column, 15 mm ID and 75 cm length. The height of the mixed bed was approximately 33 cm.

On top of the mixed bed in the column, an overlay was placed. Various resins were used for the overlay. Height of the overlay was approximately 23 cm.

Surrogate solutions were prepared in 20 ppm, 1.5 L batches in deionized water and ultrasonicated at 30 W with an immersion probe for 3 minutes in order to ensure good mixing of the solutions. The sonication was continued for the duration of the testing. The sonication resulted in a temperature rise of approximately 10° C. of the feed solution over the duration of the resin testing. Particle size analysis (Particle Technology Laboratories) of the surrogate solutions indicated that the nanopowders agglomerated upon contact with water, thus the immersion probe was also utilized to break up, to the extent possible, the nanoparticles in the feed solutions. The Co solution appeared to respond well to ultrasonication (although particulates did accumulate at the bottom of the beaker if allowed to settle).

The surrogate solutions are considered to mimic the behavior of colloidal particles found in the cooling water systems of nuclear power plants.

Resins used for overlays were as follows:
Resin-j=a repeat of Resin-e defined above (a batch of Resin-I treated with 8 hours methanol soak time and 1 hour caustic reflux).
Resin-k=a repeat of Resin-e defined above (a batch of Resin-I treated with 1 hour methanol soak time and 7 hours caustic reflux).
DOWEX™ MP725-OH resin=macroporous strong base anion exchange resin from Dow Chemical Company, styrene/DVB copolymer, quaternary ammonium functional groups; has no methylene bridges

The resin column was packed by rinsing it with deionized water downflow at a rate of approximately 130 mL/min. Column shrinkage of approximately 2 cm was observed as a result of the packing. Packing water was drained from the column prior to feed of the surrogate solution to 0.3 cm±0.1 cm above the resin. This drainage procedure was followed to minimize dilution of the feed solution and to avoid air contact with the wetted test resin. Feed solution was pumped through the resin at a flow rate of 0.5 bed volumes per minute (BV/min), and an effluent sample was collected at 1, 3, 5, 7 and 10 bed volumes (BV). The samples were assessed for Co by Inductively coupled plasma mass spectrometry (ICP-MS) or inductively couple plasma atomic emission spectroscopy (ICP-AES), and chloride (Cl) by Ion chromatography (IC).

A sample of the feed to the top of the column was collected once or twice during the testing (generally once). This was typically performed at 8 BV by disconnecting the column from the top insert (to avoid the possibility of solution hang-up in a sampling line). This sample was collected in order to ascertain how much of the surrogate solution was reaching the top of the column.

Two different portions of Resin-2 were tested in duplicate experiments. Similarly, two different portions of Resin-3 were tested in duplicate experiments. Results were as follows:

Resin-2 Overlay - first experiment

| time (min) | BV | Location | Co (ppm) | Chloride (ppm) |
|---|---|---|---|---|
| 0 | 0 | feed | 12.9 | |
| 2 | 1 | outlet | 0.006 | <0.01 |
| 6 | 3 | outlet | 0.006 | <0.01 |
| 10 | 5 | outlet | 0.005 | <0.01 |
| 14 | 7 | outlet | <0.005 | <0.01 |
| 16 | 8 | top of column | 11 | |
| 20 | 10 | outlet | <0.005 | <0.01 |

Resin-2 Overlay - second experiment

| time (min) | BV | Location | Co (ppm) | Chloride (ppm) |
|---|---|---|---|---|
| 0 | 0 | feed | 19.0 | |
| 2 | 1 | outlet | 0.014 | <0.01 |
| 6 | 3 | outlet | 0.009 | <0.01 |
| 10 | 5 | outlet | 0.007 | <0.01 |
| 14 | 7 | outlet | <0.005 | <0.01 |
| 16 | 8 | top of column | 13.0 | |
| 20 | 10 | outlet | <0.005 | <0.01 |

Resin-3 Overlay - first experiment

| time (min) | BV | Location | Co (ppm) | Chloride (ppm) |
|---|---|---|---|---|
| 0 | 0 | feed | 19.0 | |
| 2 | 1 | outlet | 0.018 | <0.01 |
| 6 | 3 | outlet | 0.024 | <0.01 |
| 10 | 5 | outlet | 0.022 | <0.01 |
| 14 | 7 | outlet | 0.025 | <0.01 |
| 16 | 8 | top of column | 11.8 | |
| 20 | 10 | outlet | 0.015 | <0.01 |

Resin-3 Overlay - second experiment

| time (min) | BV | Location | Co (ppm) | Chloride (ppm) |
|---|---|---|---|---|
| 0 | 0 | feed | 17.7 | |
| 2 | 1 | outlet | 0.048 | <0.01 |
| 6 | 3 | outlet | 0.060 | <0.01 |
| 10 | 5 | outlet | 0.066 | <0.01 |
| 14 | 7 | outlet | 0.071 | <0.01 |
| 16 | 8 | top of column | 11.2 | |
| 20 | 10 | outlet | 0.067 | <0.01 |

MP-725AOH Overlay - comparative experiment

| time (min) | BV | Location | Co (ppm) | Chloride (ppm) |
|---|---|---|---|---|
| 0 | 0 | feed | 18.5 | |
| 2 | 1 | outlet | 0.770 | <0.01 |
| 6 | 3 | outlet | 0.584 | <0.01 |
| 10 | 5 | outlet | 0.560 | <0.01 |
| 14 | 7 | outlet | 0.561 | <0.01 |
| 16 | 8 | top of column | 10.5 | |
| 20 | 10 | outlet | 0.557 | <0.01 |

The inventive examples using Resin-2 and Resin-3 showed that Resin-2 and Resin-3 both removed almost all the cobalt and did not release chloride into the water.

1. A vinyl aromatic resin comprising benzyl alcohol groups, benzyl ether groups, and methylene bridge groups,
wherein the mole ratio of the benzyl ether groups to the methylene bridge groups is from 0.002:1 to 0.1:1
wherein the vinyl aromatic resin either has no amine groups or else has amine groups in a mole ratio of the sum of all amine groups to aromatic rings of 0.1:1 or lower.

2. The vinyl aromatic resin of claim 1, with the proviso that if said vinyl aromatic resin comprises any benzyl chloride groups, the mole ratio of said benzyl chloride groups to said alkyl benzyl ether groups is from 0:1 to 0.001:1.

3. The vinyl aromatic resin of claim 1, wherein the mole ratio of the benzyl alcohol groups to the methylene bridge groups is from 0.005:1 to 0.1:1.

4. The vinyl aromatic resin of claim 1, wherein the vinyl aromatic resin has chlorine content, measured by neutron activation analysis, by weight based on the weight of resin, of 10,000 ppm or less;
